(19) United States
(12) Patent Application Publication
(10) Pub. No.: US 2003/0028453 A1
(43) Pub. Date: Feb. 6, 2003

(54) Interactive method and apparatus for determining patent license fees

(76) Inventor: Scot A. Reader, Sherman Oaks, CA (US)

Correspondence Address: Scot A. Reader, Esq., 3424 Woodcliff Road, Sherman Oaks, CA, 91403, US

(21) Appl. No.: 09/920,363

(22) Filed: Aug. 1, 2001

(51) Int. Cl. G06F 17/60

(52) U.S. Cl. 705/30

(57) ABSTRACT

A method and apparatus for determining patent license fee data in a networked computing environment. The method and apparatus involve an interactive process that provides the user of an end-user station an opportunity to modify patent license data generated by the networked computing environment for application in determining the patent license fee data.

### BACKGROUND OF THE INVENTION

A fee for a unilateral patent license in a technological field may be calculated by multiplying the licensee's product revenue in the field by an exposure risk in the field and a royalty rate in the field. A fee for a unilateral patent license in multiple technological fields may be calculated by summing the fees calculated as described above for the individual fields. A fee for a bilateral patent license may be calculated by performing one of the foregoing calculations, swapping the licensor and licensee, repeating the one of the foregoing calculations and subtracting the fee calculated in the second instance from the first to yield a “balancing payment”.

Patent licensing professionals may apply license fees calculated using these formulas offensively, to determine which potential licensing targets to engage and what license fees to expect from such targets, and defensively, to determine what licensee fees others may expect from their own clients. However, the usefulness of such calculated license fees depends on the reliability of the underlying data, including corporate affiliation data, product revenue data, exposure risk data and royalty rate data. Sometimes the patent licensing professional will have sufficiently reliable data on all these variables to make the license fee calculation with a high degree of confidence. But in many cases, the patent licensing professional will have sufficiently reliable data on only some of these variables. For instance, the patent licensing professional may glean reliable product revenue data from a market study but have no reliable data on exposure risk or royalty rate. Or the patent licensing professional may glean reliable exposure risk data from an infringement study but have no reliable data on product revenue or royalty rate. Or the patent licensing professional may glean reliable royalty rate data from an industry survey but have no reliable data on exposure risk or product revenue. For the variables on which the patent licensing professional must engage in some degree of speculation, a computer may be able to provide data of superior reliability by reference to raw or computer manipulated stored data. Yet the licensing professional often cannot know without seeing the computer generated data whether the computer generated data or his own speculative data is preferred. Moreover, since the variables about which the patent licensing professional is uncertain may have different dependencies, it may require several “looks” at different combinations of computer generated data and speculative data and the results thereof to determine a preferred combination.

### SUMMARY OF THE INVENTION

In one aspect, the present invention facilitates rational patent license fee determinations through the expedient of an interactive patent license fee determination process. An exemplary method comprises: inputting by a user on a computer first patent license data; processing the first patent license data using a first interaction involving the computer to determine second patent license data; outputting on the computer the second patent license data; modifying by a user at least part of the second patent license data to produce modified second patent license data; inputting on the computer the modified second patent license data; processing the modified second patent license data using a second interaction involving the computer to determine third patent license data; and outputting on the computer the third patent license data.

In another aspect, at least one of the first or second interactions further involves a database.

In yet another aspect, a networked computing system comprises an end-user station having a user interface, for interacting with a user, and a network interface, for interacting with a network, wherein the end-user station interacts with the user and the network to determine patent license fee data including providing the user an opportunity to modify patent license data generated in an interaction involving the network for application in determining the patent license fee data.

In yet another aspect, a computer program has instructions for interacting with an end-user station, a user and a network to determine patent license fee data in function of patent license data, wherein the patent license data include data generated in an interaction of the computer program involving the network and modified in an interaction of the computer program involving the user.

In yet another aspect, a computing system comprises an end-user station having a user interface for interacting with a user, wherein patent license fee data are determined in an iterative interaction involving the user and the end-user station. In another aspect, the iterative interaction further involves a network.

These and other objects of the present invention may be better understood by reference to the following detailed description, taken in conjunction with the accompanying drawings briefly described below. Of course, the actual scope of the invention is defined by the appended claims.

### BRIEF DESCRIPTION OF THE DRAWINGS

FIG. 1 illustrates a networked computing environment for use in interactive determination of patent license fees;

FIG. 2 is a flow diagram illustrating a method for interactively determining a unilateral patent license fee for a single technological field;

FIG. 3 is a flow diagram illustrating a method for interactively determining a unilateral total patent license fee for multiple technological fields;

FIG. 4 is a flow diagram illustrating a method for interactively determining a bilateral patent license fee for a single technological field; and

FIG. 5 is a flow diagram illustrating a method for interactively determining a bilateral net patent license fee for multiple technological fields.

### DETAILED DESCRIPTION OF THE PREFERRED EMBODIMENT

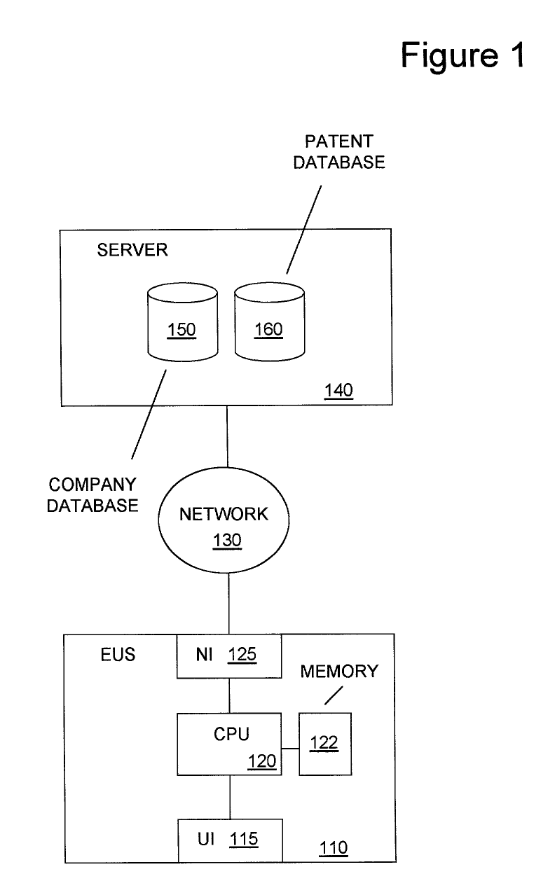

In FIG. 1, a networked computing environment for use in interactive patent license fee determination is shown. The environment includes end-user station (EUS) 110, such as a personal computer or workstation, having user interface (UI) 115, processor (CPU) 120, memory 122 and network interface (NI) 125. End-user station 110 receives and transmits data on user interface 115, processes data, in conjunction with memory 122, using processor 120 and exchanges data with server 140 over network interface 125. Network interface 125 may be a wired or wireless interface. Data exchanges are performed via network 130, such as a LAN or WAN, and involve retrieving information from company database 150 and patent database 160. Memory 122 stores data, including software program instructions for a software program loaded on end-user station, data input by the user and data retrieved in data exchanges. Processor 120 uses stored data, including the software program instructions, to provide functionality described herein. Particularly, functionality referenced as being performed by processor 120 involves execution of software program instructions retrieved from memory 122. Company database 150 has entries for possible licensors and licensees including lists of affiliated legal entities and global revenue data. Patent database 160 has entries for patents including patent numbers, assignee names, filing dates, grant dates, maintenance status data and patent classification numbers. The patent classification numbers may be international classification numbers or U.S. classification numbers. Patent database also includes royalty rates by patent classification number. Server 140 may, in addition to databases 150, 160, include processing elements applied, for instance, in interacting with databases 150, 160 to generate search results for search queries received from end-user station 110. Of course, databases 150, 160 may in other embodiments of the invention reside on different servers.

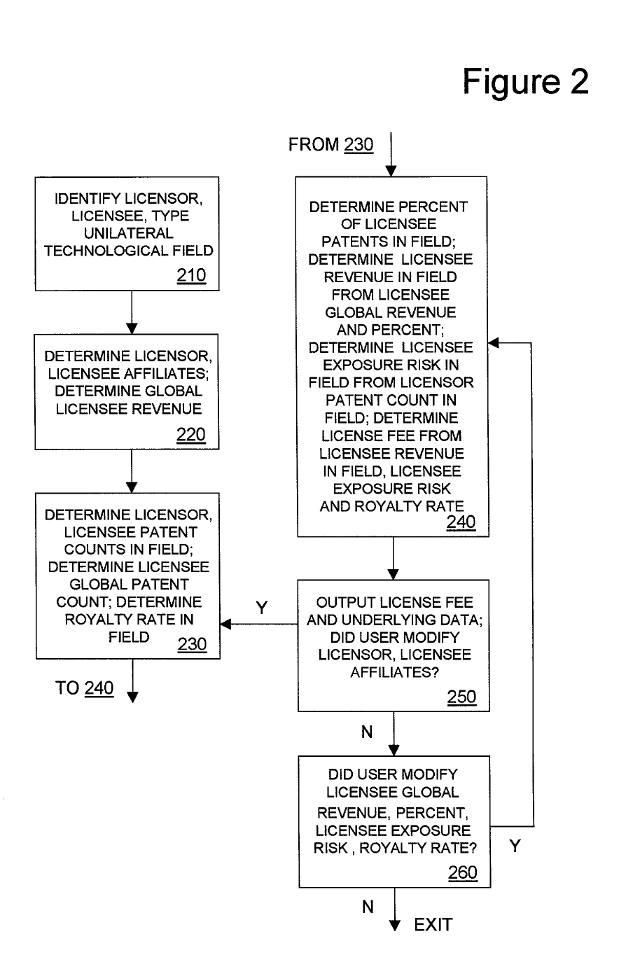

In FIG. 2, a flow diagram illustrates an interactive method for determining a unilateral patent license fee for a single technological field. As applied within the networked computing environment of FIG. 1, a user of end-user station 110 is prompted via user interface 125 by processor 120 to identify a licensor, licensee, license type and technological field. The user inputs the requested information on user interface 115 and selects type unilateral. The technological field may be input in the form of a patent classification number. Processor 120 caches the license type and technological field in memory 122. Step 210 is thereby completed. Processor 122 forms licensor and licensee company search queries for company database 150 based on the licensor identity and the licensee identity, respectively, and the respective company search queries are transmitted over network 130 from end-user station 110 to server 140 via network interface 125. At server 140, the respective company search queries are applied to company database 150 to generate respective company search results, including respective lists of affiliated legal entities and, for the licensee, global revenue. The respective company search results are transmitted from server 140 to end-user station 110 via network 130 and network interface 125. Step 220 is thereby completed. Processor 120 forms respective licensor and licensee patent search queries for patent database 160 based on the respective lists of affiliated legal entities and cached technological field. The respective patent search queries are transmitted from end-user station 110 to server 140 via network 130 and network interface 125. If the technological field was not input in the form of a patent classification number, processor 120 replaces the technological field with a corresponding patent classification number in forming the respective patent search queries. At server 140, the respective patent search queries are applied to patent database 160 to generate respective patent search results, including respective patent counts within the corresponding patent classification for which the licensor- and licensee-affiliated legal entities, respectively, are named as an assignee and additionally, for the licensee-affiliated legal entities, a global patent count. The configured royalty rate associated with the patent classification is also retrieved from the patent database 160 and applied to the search results. The respective patent search results are transmitted from server 140 to end-user station 110 via network 130 and interface 125. Step 230 is thereby completed. At end-user station 110, processor 120 divides the patent classification-based patent count for the licensee-affiliated legal entities by the global patent count for the licensee-affiliated legal entities to calculate the percentage of the licensee global patent count attributable to the technological field. Processor 120 further multiplies the global revenue for the licensee by the percentage to calculate the licensee revenue attributable to the technological field. Processor 120 further calculates an exposure risk for the licensee in the technological field in function of the licensor patent count in the corresponding patent classification. In a preferred embodiment, the licensor patent count is multiplied by a configured “per patent” exposure risk percentage to obtain the licensee exposure risk, with the licensee exposure risk being capped at one hundred percent. Processor 120 further multiplies the licensee revenue in the technological field by the licensee exposure risk and the royalty rate for the technological field to determine the license fee. Step 240 is thereby completed. The license fee is supplied as an output to the user on user interface 115 with underlying data on which the license fee determination is based, including the parties' respective lists of affiliated legal entities, the licensee global revenue data, the calculated percent of licensee revenue attributable to the technological field, the calculated exposure risk and the configured royalty rate. The user is provided the opportunity to modify the underlying data. If the user modifies the parties' respective lists of affiliated legal entities, or either of them, the user is warned of the dependency of the licensee revenue attributable to the technological field (if the licensee's list is modified) and licensee exposure risk (if the licensor's list is modified). If the user elects to proceed despite the dependency warning (250), the process returns to Step 230 and the license fee is re-determined. If the user modifies the licensee global revenue, the percentage of licensee revenue attributable to the technological field, the licensee exposure risk and the royalty rate, or any of them (260), the process returns to Step 240 and the license fee is re-determined. Attempts by the user to set the percentage of licensee revenue attributable to the technological field, licensee exposure risk or royalty rate below zero percent or above one hundred percent are inhibited. The license fee re-determinations proceed until the user declines the opportunity to modify any of the underlying data. Re-determinations commence upon the user making an affirmative indication, such as a mouse click or a keystroke, after making all desired modifications.

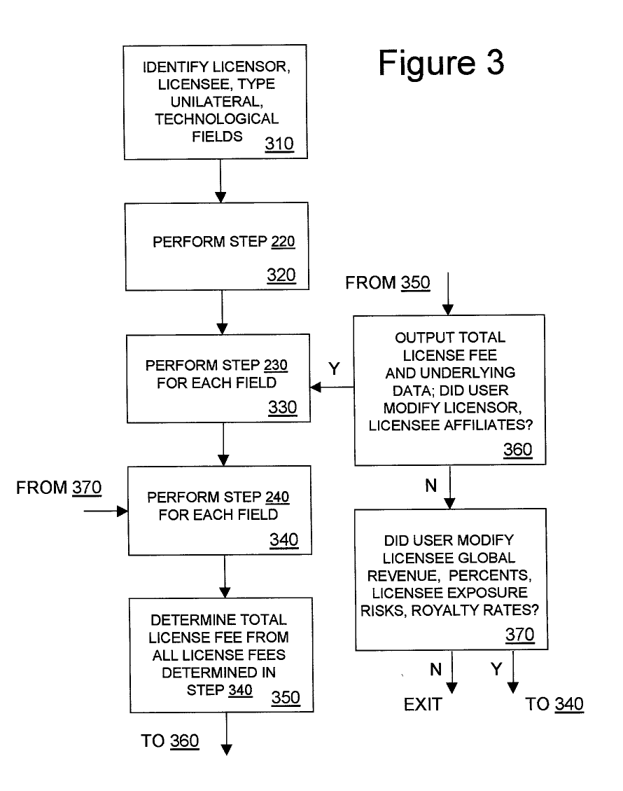

Turning now to FIG. 3, a flow diagram illustrates a method for determining a unilateral patent license fee in multiple technological fields. As applied within the networked computing environment of FIG. 1, a user of end-user station 110 is prompted to identify a licensor, licensee, license type and technological field. The user inputs the requested information and selects type unilateral, only this time the user identifies multiple technological fields (310). The interactions of processor 120 with company database 150 and patent database 160 proceed as described in Step 220 through 240, only this time Steps 230 and 240 are performed for multiple technological fields (320, 330, 340). The “per field” license fees calculated in Step 340 are summed to determine a total license fee (350). The total license fee is supplied as an output to the user with underlying data on which the total license fee determination is based, including the parties' respective lists of affiliated legal entities, the licensee global revenue and, for each technological field, the percentage of licensee revenue attributable, the licensee exposure risk and the royalty rate. The user is provided the opportunity to modify the underlying data. If the user modifies the parties' respective lists of affiliated legal entities, or either of them, the user is warned of the dependency of the licensee revenues attributable to the technological fields (if the licensee's list is modified) and licensee exposure risks (if the licensor's list is modified). If the user elects to proceed despite the dependency warning (360), the process returns to Step 330 and the total license fee is re-determined. If the user modifies the licensee global revenue, the percentages of licensee revenue attributable to the technological fields, the licensee exposure risks and the royalty rates, or any of them (370), the process returns to Step 340 and the total license fee is re-determined. Attempted modifications which would result in the aggregate percent of licensee revenue attributable to the technological fields exceeding one hundred percent are not accepted. Moreover, attempts to set licensee exposure risks and royalty rates below zero percent or above one hundred percent for a given technological field are not accepted. The license fee re-determinations proceed until the user declines the opportunity to modify any of the underlying data.

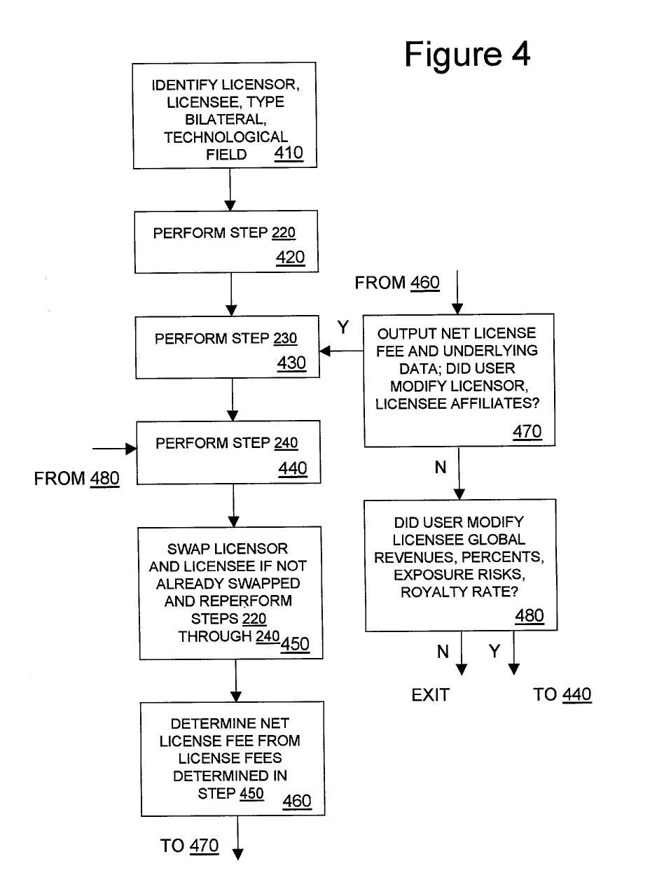

Turning next to FIG. 4, a flow diagram illustrates a method for determining a bilateral patent license fee in a single technological field. As applied within the networked computing environment of FIG. 1, a user of end-user station 110 is prompted to identify a licensor, licensee, license type and technological field. The user inputs the requested information, only this time the user selects type bilateral (410). The interactions of processor 120 with company database 150 and patent database 160 proceed as described in Steps 220 through 240 (420, 430, 440). The licensor and licensee are swapped and Steps 220 through 240 are re-performed (450). The license fee calculated in the second instance of Step 440 for the licensee's reciprocal grant to the licensor is subtracted from the license fee calculated in the first instance of Step 440 for the licensor's grant to the licensee to produce a net license fee, i.e. “balancing payment” (460). The net license fee is supplied as an output to the user with underlying data on which the license fee determination is based, including, the parties' respective lists of affiliated legal entities, respective global revenues, respective percentages of revenue attributable to the technological field, respective exposure risks in the technological field, and the royalty rate in the technological field. The user is provided the opportunity to modify the underlying data. If the user modifies the parties' respective lists of affiliated legal entities, or either of them, the user is warned of the dependency of the revenue attributable to the technological field and exposure risk. If the user elects to proceed despite the dependency warning (470), the process returns to Step 430 and the net license fee is re-determined. If the user modifies the parties' respective global revenues, respective percentages of revenue attributable to the technological field and respective exposure risks, and the royalty rate, or any of them (480), the process returns to Step 440 and the net license fee is re-determined. The net license-fee re-determinations proceed until the user declines the opportunity to modify the underlying data.

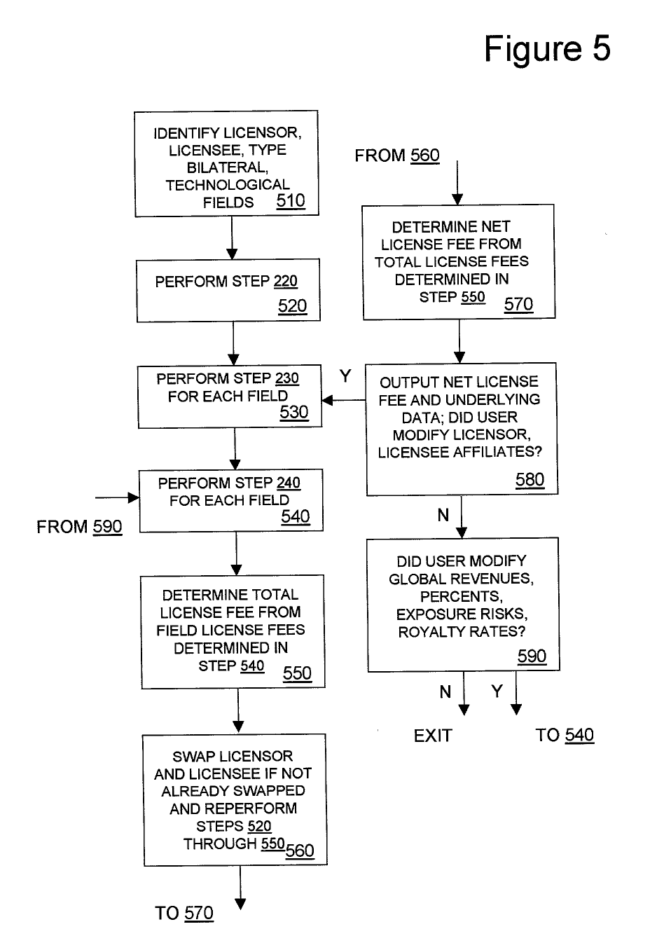

Turning finally to FIG. 5, a flow diagram illustrates a method for determining a bilateral patent license fee in multiple technological fields. As applied within the networked computing environment of FIG. 1, a user of end-user station 110 is prompted to identify a licensor, licensee, license type and technological field. The user inputs the requested information, only this time the user selects type bilateral and identifies multiple technological fields (510). The interactions of processor 120 with company database 150 and patent database 160 proceed as described in Step 220 through 240, only this time Steps 230 and 240 are performed for multiple technological fields (520, 530, 540). The “per field” license fees calculated in Step 540 are summed to determine a total license fee (550). The licensor and licensee are swapped and Steps 520 through 550 are re-performed (560). The total license fee calculated in the second instance of Step 540 for the licensee's reciprocal grant to the licensor is subtracted from the total license fee calculated in the first instance of Step 540 for the licensor's grant to the licensee to produce a net license fee, i.e. “balancing payment” (570). The net license fee is supplied as an output to the user with underlying data on which the net license fee determination is based, including, the parties' respective lists of affiliated legal entities, respective global revenues and, for each technological field, the parties' respective percentages of revenue attributable and respective exposure risks, and the royalty rates. The user is provided the opportunity to modify the underlying data. If the user modifies the parties' respective lists of affiliated legal entities, or either of them, the user is warned of the dependency of the revenue attributable to the technological fields and exposure risks. If the user elects to proceed despite the dependency warning (580), the process returns to Step 530 and the net license fee is re-determined. If the user modifies the parties' respective global revenues, respective percentages of revenue attributable to the technological fields, respective exposure risks, and the royalty rates, or any of them (580), the process returns to Step 530 and the net license fee is re-determined. The net license fee re-determinations proceed until the user declines the opportunity to modify the underlying data.

It will be appreciated by those of ordinary skill in the art that the invention can be embodied in other specific forms without departing form the spirit or essential character hereof. The present description is therefore considered in all respects illustrative and not restrictive. The scope of the invention is indicated by the appended claims, and all changes that come within the meaning and range of equivalents thereof are intended to be embraced therein.

I claim:

1. An interactive method for determining a patent license fee, comprising:
inputting on a computer first patent license data;
processing the first patent license data using a first interaction involving the computer to determine second patent license data;
outputting on the computer the second patent license data;
modifying at least part of the second patent license data to produce modified second patent license data;
inputting on the computer the modified second patent license data;
processing the modified second patent license data using a second interaction involving the computer to determine third patent license data; and
outputting from the computer the third patent license data.

2. The method of claim 1, wherein at least one of the first or second interactions further involves a database.

3. The method of claim 1, wherein the third patent license data include patent license fee data.

4. The method of claim 1, wherein the second patent license data include a list of affiliated companies.

5. The method of claim 1, wherein the second patent license data include global revenue data for a licensee.

6. The method of claim 1, wherein the second patent license data include a licensee's revenue attributable to a technological field.

7. The method of claim 1, wherein the second patent license data include an exposure risk.

8. The method of claim 1, wherein the second patent license data include a royalty rate.

9. The method of claim 1, wherein the first patent license data include a licensee's name.

10. A networked computing system, comprising:
an end-user station having a user interface, for interacting with a user, and a network interface, for interacting with a network,
wherein the end-user station interacts with the user and the network to determine patent license fee data including providing the user an opportunity to modify patent license data generated in an interaction involving the network for application in determining the patent license fee data.

11. The system of claim 10, wherein the interaction with the network involves a database.

12. The system of claim 10, wherein the patent license data include a list of affiliated legal entities.

13. The system of claim 10, wherein the patent license data include global revenue data for a licensee.

14. The system of claim 10, wherein the patent license data include a licensee's revenue attributable to a technological field.

15. The system of claim 10, wherein the patent license data include an exposure risk.

16. The system of claim 10, wherein the patent license data include a royalty rate.

17. A computer program having instructions for interacting with an end-user station, a user and a network to determine patent license fee data in function of patent license data, wherein the patent license data include data generated in an interaction of the computer program involving the network and modified in an interaction of the computer program involving the user.

18. The program of claim 17, wherein the interaction involving the network involves a database.

19. The program of claim 17, wherein the patent license data include a list of affiliated legal entities.

20. A computing system, comprising:
an end-user station having a user interface for interacting with a user,
wherein patent license fee data are determined in an iterative interaction involving the user and the end-user station.

21. The system of claim 20, wherein the end-user station further has a network interface for interacting with a network and the iterative interaction further involves the network.

22. The system of claim 20, wherein the iterative interaction includes a first patent license data output on the end-user station followed by a patent license data input on the end-user station in response to the first patent license data output followed by a second patent license data output on the end-user station in response to the patent license data input.

23. The system of claim 22, wherein at least the second patent license data output includes patent license fee data.
